(19) United States
(12) Patent Application Publication
(10) Pub. No.: US 2008/0256454 A1
(43) Pub. Date: Oct. 16, 2008

(54) Selection of list item using invariant focus location

(75) Inventors: Markus Latzina, Wiesenbach (DE); Anoshirwan Soltani, Frankfurt (DE)

Correspondence Address: SCHWEGMAN, LUNDBERG & WOESSNER/SAP, P.O. BOX 2938, MINNEAPOLIS, MN, 55402, US

(73) Assignee: SAP AG

(21) Appl. No.: 11/786,967

(22) Filed: Apr. 13, 2007

(51) Int. Cl. G06F 3/00; G06F 3/048

(52) U.S. Cl. 715/732; 715/810

(57) ABSTRACT

A method to perform selection of a list item using an invariant selection location includes retrieving multiple data items to present for selection by a user. A single invariant selection location is recognized within a presentation window presented to the user. A subset of the multiple data items are then presented to the user within the presentation window, each of the presented data items are being presented within a respective presentation position defined within the presentation window. A single advance input mechanism is associated with the presentation window. The single advance input mechanism is operative to advance the presentation of data items within the presentation window. An advance input is received from the user, via the advanced input mechanism. The presentation of the subset of data items within the presentation window is advanced to locate a selected data item at the invariant selection location.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2007, SAP AG, All Rights Reserved.

### FIELD

Example embodiments relate to methods and systems for data processing and/or presentation

### BACKGROUND

The simplification of user interface operability is a design challenge faced by every user interface developer. Specifically, where an application has limited “real estate” (e.g., area) available on a screen for the display of the user interface, such challenges may be exacerbated. Consider the example of an application operating on a mobile or handheld device having a small screen as compared to the screen area available to a full-blown desktop application. It will be appreciated that a number of challenges exist with respect to the design of user interfaces for applications executing on a mobile or handheld device. Area limitations may also apply to desktop applications, for example, where the desktop application is of the “widget” type (e.g., a mini application), where the available user interface area is deliberately limited. Further, the user interface of desktop applications may typically be divided into a number of smaller display areas or windows, each having a limited display of real estate.

Even where abundant display real estate is available to an application, the simplification and increase in the usability of user interface features may enhance a software application.

### BRIEF DESCRIPTION OF DRAWINGS

Some embodiments are illustrated by way of example and not limitation in the figures of the accompanying drawings in which:

FIG. 1 is a block diagram illustrating an architecture for an application, according to an example embodiment, within which example embodiments of the present invention may be implemented.

FIG. 2 is a block diagram illustrating the architecture of a presentation window definition, according to an example embodiment.

FIGS. 3-4 show flowcharts illustrating a method to represent a list of data items for selection using an invariant focus location, according to an example embodiment.

FIGS. 5-9 are representations of various design variants, according to example embodiments, of data item presentation windows.

FIGS. 10-13 are screenshots illustrating display screens, according to example embodiments, incorporating presentation windows for the presentation of lists of data items for user selection.

FIG. 14 is a block diagram of machine in the example form of a computer system within which instructions, for causing the machine to perform any one or more of the methodologies discussed herein, may be executed.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

For the purposes of illustration, example embodiments are discussed below within the context of applications executing on handheld or mobile devices having small screens. However, it should be noted that embodiments are not limited to such applications, and desktop applications (or other applications executing on devices having large user interfaces) may equally well benefit from their simplicity of design and ease of use.

As an example, handheld applications are frequently utilized in mobile contexts of usage, which may present certain challenges. Handheld applications, for example, may seek to provide single-handed usage, and may require operation by discrete pushes of buttons or keys, rather than by using a pointer device, such as a mouse or stylus. Further, a user of a handheld application may have a limited timeframe or a short attention span during which the handheld application can be viewed and manipulated. Accordingly, considering an example of handheld application, for a user task of selecting an item (e.g., a menu item) from a list of items (e.g., a menu list), a number of characteristics may be desirable. For example, it may be desirable to enable a user to find a desired item from among all available items within the limitations of a relatively small available user interface area of the application. Further, it may be desirable to enable a user to select an item without having to visually scan a list of all available items, in order to minimize search and verification time. Further, it may be desirable to enable a user to use a control that is simple and easy to use in order to avoid ambiguity regarding which key is to provide which functions. Even further, it may be desirable to enable a user to interrupt a task (e.g., to locate and verify a desired item), and to enable the user to resume the task following such an interruption.

A number of the characteristics listed above with respect to item selection from a list of items on a handheld application are also applicable to the navigation of item lists (e.g., menus) presented by set-top boxes, for example, where a user is required to navigate using a remote control. For example, to navigate a set-top box application using a remote control, a pointer device (e.g., a mouse) is typically not available, navigation is performed again using discrete pushes of buttons. As such navigation is typically being performed by utilizing a remote control, there is an advantage in enabling single-handed usage. According to an example embodiment, both method and system for enabling the selection of a list item are provided using an invariant focus location within a presentation window. Multiple data items may be retrieved for presentation and selection of at least one data item by a user (e.g., within a scrolling menu presented within a presentation window). An example presentation window may include multiple presentation positions, which may be occupied by one of the multiple data items. One of these presentation positions may be recognized as a single invariant selection location within the presentation window.

A subset of the multiple data items may be presented within the presentation window, each of the presented data items being presented in a respective presentation position of the multiple presentation positions defined within the presentation window. A single advance input mechanism (e.g., action button) may be associated with the presentation window, the advance input mechanism operatively to advance the presentation of the multiple data items relative to the presentation positions within the presentation window. In an embodiment, the advance input mechanism may advance the presentation of the data items in a single direction through the presentation window.

An advance input may be received (e.g., from a user) via the advance input mechanism (e.g., the action button), responsive to which the presentation of the multiple data items may be advanced relative to the presentation positions within the presentation window to locate a selected data item at the invariant selection location.

Responsive to the location of the selected data item at the invariant selection location, one or more operations may be performed related to, or associated with, the selected data item. For example, the operation may be automatically performed in response to the location of the selected data item in the invariant selection location. In a further embodiment, the operation may be performed only responsive to a specific action input, as well as the location of the selected data item at the invariant selection location.

The associating of the single advance input mechanism with the presentation window may include associating a control graphic icon, displayed within a graphical user interface, with the presentation window. In another embodiment, the associating of the single advance input mechanism may include an associating a physical input mechanism on a device (e.g., a button on a handheld device with the presentation window in order to enable the advancement of the data items through the presentation positions within the presentation window).

The multiple data items may constitute a list of data items, and the presentation of a subset of the multiple data items may include presenting a window to a user that includes the list of data items.

The presentation window may be presented within a graphical user interface, and the presenting of the subset of data items may include presenting at least first and second data items within the presentation window, while hiding a third data item of the multiple data items from presentation within the presentation window. It will be appreciated that terms “first”, “second”, and “third” as used here do not indicate the order of how these items are displayed during the advancing of the list. Further, a list of data items or a subset from the list of data items may be presented as a looped list during its presentation within the presentation window. It will be appreciated that such looped presentation within the presentation window need not correspond to the database arrangement of data lists that are used for either the looped list of data items or its looped subset within the presentation window.

The receiving of the advance input (e.g., from a user via an action button) may include receiving a discrete input via the advance input mechanism, and the method may further include advancing the data items within the presentation window by a single presentation position increment.

Alternatively, the receiving of the advance input may include receiving a continuous input via the advance input mechanism. In response to receiving such a continuous input, the method may include performing a continual advancing of the multiple data items through the presentation positions within the presentation window for a duration of the receipt of the continuous input. The advancing of the presentation of the multiple data items may further include either a vertical or horizontal scrolling of the looped data items within the presentation window.

It will be appreciated that in certain example embodiments a single-handed device operation is preferable due to the other hand being occupied with a different task. As an example, in the context of a shop floor, personnel is often required to manipulate machine controls or other parts of thereof during its operation and at the same time needing one hand to lift the cover of a display instrument to record instrument readings and to input the readings into the handheld device.

Some example embodiments include people having one hand occupied or missing and needing to use a handheld device to look up, for example, an address or some other information. System variables, for example, time can be used as a default for selected and displayed items. Thus, one of the example embodiments may include company personnel using the advancing mechanism of a presentation module while inspecting the current temperature of goods with the current temperature being read automatically and inserted into the presentation module. The user of such advancing mechanism should be able to select among automatically triggered default values such as, for example, “send alert”, “increase cooling”, or “switch on emergency sound”.

Further example embodiments may include voice input as a means to operate the advance mechanism with example commands such as “go”, “next”, “advance”, or “skip” or by mere gestures when voice commands are either impossible or undesirable utilizing use of a wireless controller. To this end a handheld pointing device can be used to detect motion and rotation in three dimensions. Further such example embodiments include an ability of the controlled device to interact with the operator by voice output.

The multiple data items that are unselected or unselectable can be used to merely display instructional text, for example, “push button to advance this list”, or, “currently this list is sorted according to the alphabet” with the unselected or the unselectable data items being changed according to frequency of use or according to proximity to the selected data item when the screen with the proposed control is displayed the advancing could start automatically and a user can use advance button to toggle through these modes. Example modes include “stop advancing and select item”, “increase speed of advancing of list”, “lower speed of advancing of list”, “start advancing of list in discreet steps”, or “start advancing of list in continuous flow”.

Further examples, may include, a dynamic rendering of the default display of the list by using the system variables, such as time, for example, to fill the individual presentation areas. For example, the hours which contain 2 digits could be rendered by two proposed controls, with the first control displaying the “tens” and the second the “ones” and thus allowing to display and select minutes from “00” to “60” in increments of “1”. As an example, the digits could display the current minutes, for example “2” “4” meaning “24 minutes”. Further benefits of using a single advance button include preventing users from the risk of inadvertently using a wrong button, as, for example, where users can advance the list in either direction. Thus, when using the advance input mechanism, users do not need to make a decision as to which input mechanism to use due to availability of single direction of such advancing.

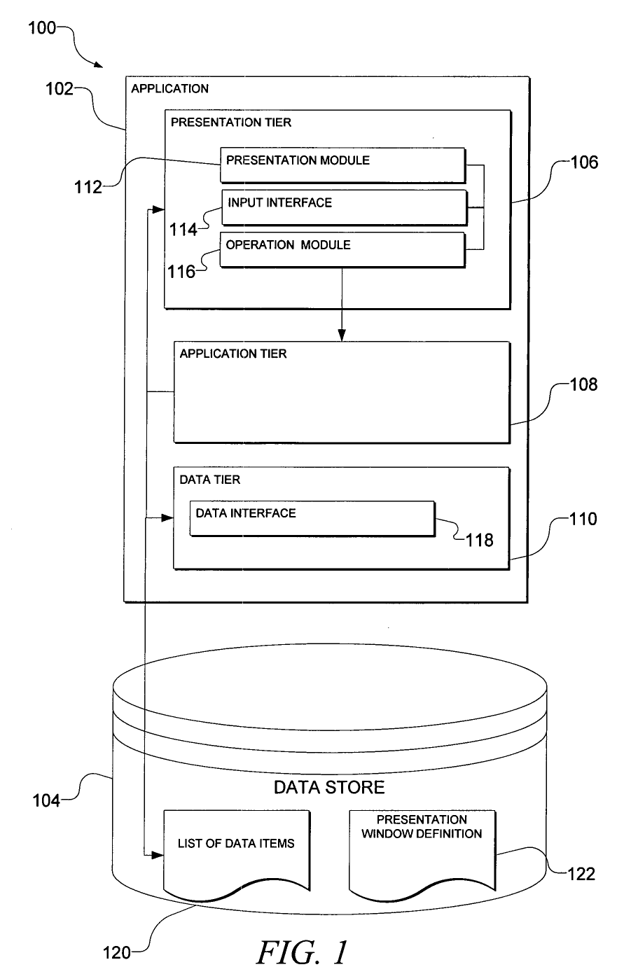

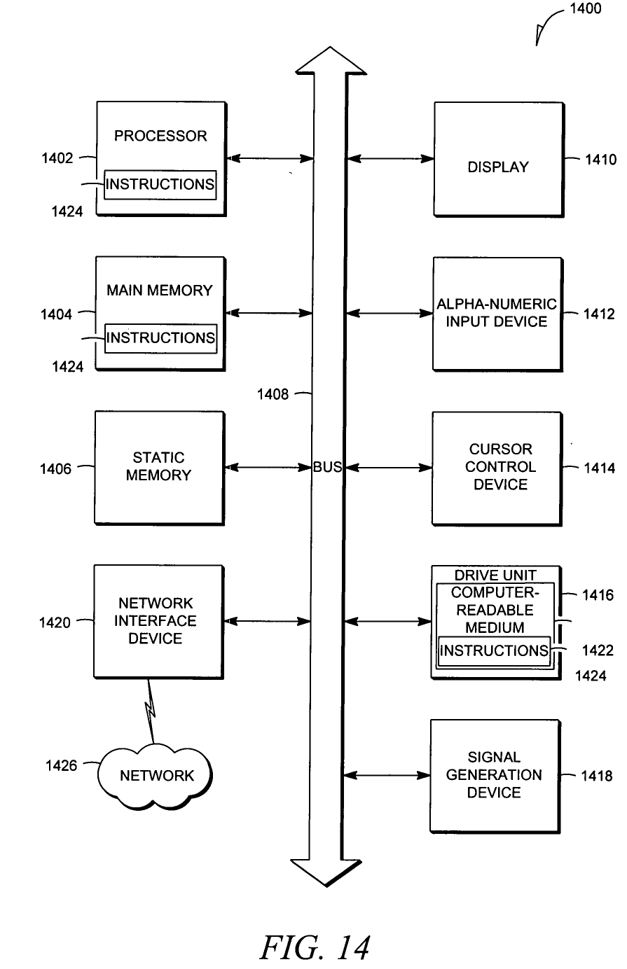

FIG. 1 is a block diagram illustrating a system 100, according to an example embodiment, within which the present application may be implemented and deployed. The system includes an application 102 (e.g., executing on a machine as further described below with reference to FIG. 14, the application 102 having access to a data store 104. The application 102 may, for example be a standalone application executing on a device (e.g., a handheld device, set-top box or computer system), or may be a distributed application, with the various components thereof executing on different machines. The application 102 may, for example, include a presentation tier 106, an application tier 108, and a data tier 110. In the standalone application example, each of these tiers may be implemented and executed in the context of a single device. In other embodiments, the presentation, application and data tiers 106, 108 and 110 may execute on different machines. For example, the application tier 106 may execute on a handheld device, and communicator (e.g., via a network) with the application tier 108 and the data tier 110.

The presentation tier is shown to include a presentation module 112 that is responsible for the generation of user interface elements (e.g., through the interpretation of definitions of such user interface elements) and input interface 114 to receive user input provided using a presented user interface, and an operation module 116 to perform and/or initiate certain operations responsive to input received via the input interface. To this end, the operation module 116 is shown to be communicatively coupled to the application tier (e.g., through an appropriate messaging structure) to invoke the functionality provided at the application tier.

The application tier 108 may include any number of application components or modules, the nature and functioning of which is dependent upon the type of application.

The data tier 110 is shown to be communicatively coupled to both the application tier and the presentation tier, and includes a data interface 118 which is responsible for retrieving information from, and providing information to, the data store 104. The retrieval of information from and provision of data to the data store 104 may, for example, be based on the input/output requirements of the application tier 108 or the presentation tier 106.

The data store (which may comprise a remote database or local storage on a particular machine or device) is shown, in the example embodiment to store a list of data items 120 that may be presented, via components of the presentation tier, to a user of the application 102 for selection. For example, the list of data items 120 may be presented as a menu of input choices, particular to the application, from which a user may select in order to provide input to components of the application tier 108.

The data store may also include definitions for any number of graphical user interface components that are rendered by the presentation module 112, utilizing the relevant definitions. Among the definitions may be a presentation window definition 122, which in turn contains a number of sub-definitions.

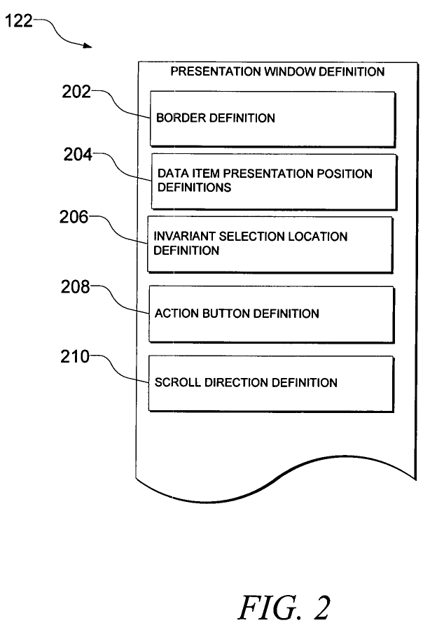

FIG. 2 is a block diagram illustrating the components of a presentation window definition 122, according to an example embodiment. Specifically, the example presentation window definition may define a window within which a selection or a menu of data items is presented to a user for selection and/or action. The example presentation window definition 122 shown in FIG. 2 includes a border definition 202 that defines a border of the relevant presentation window, as well as characteristics of that border (e.g., width, depth, etc.). Data item presentation position definitions 204 may identify multiple positions within a presentation window, in which data items may be displayed. In the example where the presentation window is horizontally expansive, the data item presentation position definitions 204 may vertically divide the presentation window into a number of discrete presentation positions that remain fixed relative to the border definition. In another embodiment, the position definitions may be dynamically variable (e.g., variable in size) based on various criteria and operating conditions (e.g., the number of data items to be displayed).

An invariant selection location definition 206 may identify one of the presentation positions as an invariant selection location (e.g., a focus location). A data item, in an example embodiment, located within the invariant selection location may be regarded as a “selected” data item from multiple data items that are displayed within a presentation window. Further details regarding characteristics and operational usage of the invariant selection location are described below.

An advanced input mechanism, may, in an example embodiment, be an action button definition 208, which defines an action button, associated with a presentation window, a user selection which may operatively advance data items, displayed within the presentation window, sequentially through presentation positions defined within the presentation window. It may be user selectable in a discrete manner (e.g., as a single click or selection operation to incrementally advance or move data items through the presentation positions within a presentation window). The action button may also be capable of continuous selection by a user, to perform a continuous advancing or scrolling of the data items through the presentation positions. A scroll direction definition 210 may be associated with the action button definition, and define a single direction in which data items are advanced through the presentation positions. For example, where the presentation window allows horizontal scrolling, the scroll direction definition may dictate that the scrolling is from left to right, or vice versa. Similarly, where the presentation window allows vertical scrolling, the scroll direction definition 210 may dictate that the scrolling occurs in an upward direction, or a downward direction.

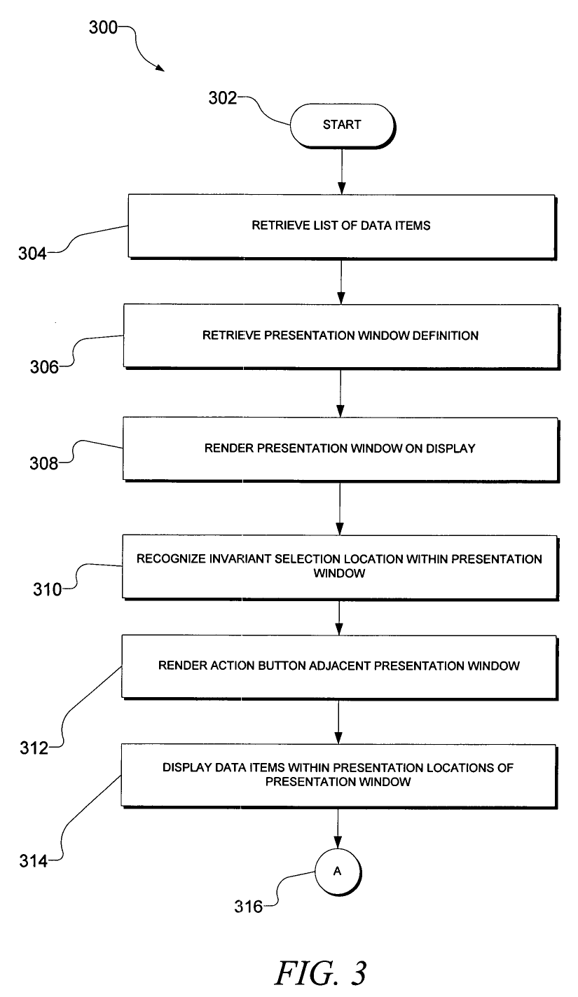

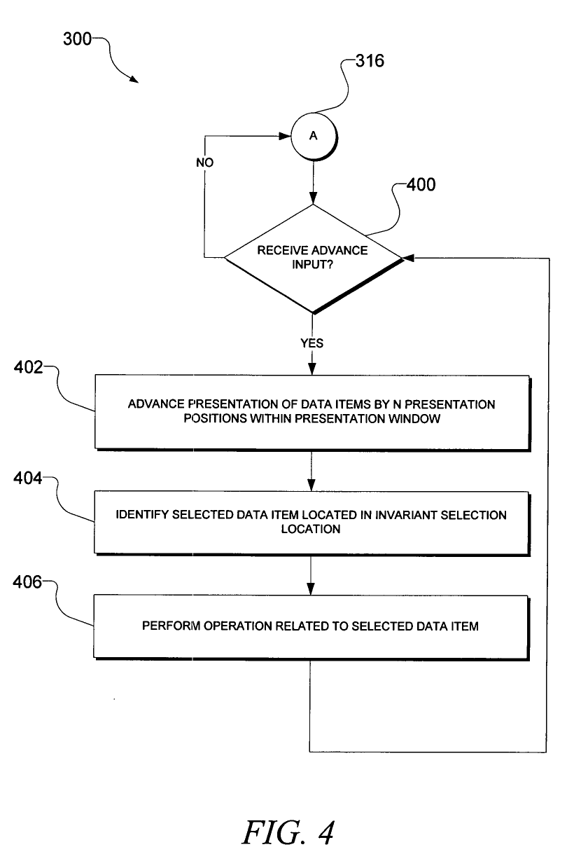

FIGS. 3 and 4 show a flowchart illustrating a method 300, according to an example embodiment, to enable selection of a list item (e.g., as presented in a menu) using an invariant focus location defined within a presentation window of a graphical user interface.

The method 300 commences at 302, and proceeds to operation 304 where the data interface 110, responsive to requests from components of the presentation tier 106, retrieves multiple data items, in the example form of a list of data items 120, from the data store 104. For example, the retrieval of this information by the data interface may be invoked responsive to a need for the application 102 to present a particular graphical user interface in which the list of data items 120 is to be presented to a user.

At operation 306, the data interface 118 may similarly retrieve definitions for multiple elements, templates, etc. that define the user interface. Included within the retrieved definitions may be the presentation window definition 122, described below.

At operation 308, the presentation module 112 of the presentation tier 106 proceeds to render the presentation window within the context of a graphical user interface on display of a device (e.g., a handheld device). The rendering of the presentation window may include rendering the various components of a presentation window, as defined by the various definitions described above with reference to FIG. 2. For example, a border may be rendered and multiple presentation positions (or locations) may be defined within the confines of the rendered border.

At operation 310, the presentation module 112 may recognize one of the presentation locations as an invariant selection location, based on the invariant selection location definition 206.

At operation 312, the presentation module 112 may render a single advance input mechanism, in the example form of an action button, adjacent to the presentation window so as to associate the action button with the presentation window.

At operation 314, the presentation module 112 proceeds to render and display data items from the list of data items retrieved at operation 304. During operation 314 the data items may be presented as a looped list, allowing the user to repeatedly reach the same data item by using the single advance input mechanism. It will be appreciated that, in some example use scenarios, the number of data items within the looped list may exceed the number of presentation positions or locations within the presentation window. Accordingly, at operation 314, only a subset of the multiple data items may be displayed within the presentation locations at operation 314, with the remainder of the data items being “hidden”. As the looped list is rotated or scrolled, utilizing the action button for example, certain data items may “fall off” the subset of display data items, while other data items may be included within the subset to be displayed.

From operation 314, the method 300 progresses to decision block 400 where the input interface 114 on the presentation tier 106 makes a determination as to whether an advance input has been received (e.g., by a user selection of the action button rendered at operation 312).

In the absence of any received advance input, the method enters a loop state. On receipt of an advance input, the method 300 progresses to operation 402, where the presentation module advances the presentation of the list of data items 120 by a number of presentation positions within the presentation window. As noted above, a single user selection event (e.g., a click on the action button) by a user may, in one embodiment, invoke a one position increment advance of the looped list through the presentation window. Further, a continuous selection of event with respect to the action button may invoke a continuous scrolling of the list of data items 120 through the presentation positions of the presentation window.

At operation 404, the operation module 116 may identify a selected data item as being located within the invariant selection location within the presentation window, as a result of the advancing (e.g., scrolling) operation performed at operation 402. The identification of a particular data item in the invariant selection location may thus, in and of itself, constitute a selection of that data item.

At operation 406, the operation module 116 may then itself perform or invoke performance as described above, of an operation related to the selected data item 406. In one embodiment, the operation may be invoked or performed solely as a result of the advancing of the selected data item to the invariant selection location, with no further action or input required from the user. In another embodiment, in order to invoke an operation associated with or related to the selected data item, the user may be required to perform a further action input in order to invoke the operation associated with the selected data item.

Upon completion of performance of the operation associated with, or related to, the selected data item, the method may loop back to decision operation 400 (in order to determine whether a further selection of a data item from the looped list is to be provided). Alternatively, the execution of operation may result in the application no longer presenting the relevant user interface, or needing to present the options of the looped list to the user, in which case the method 300 may terminate.

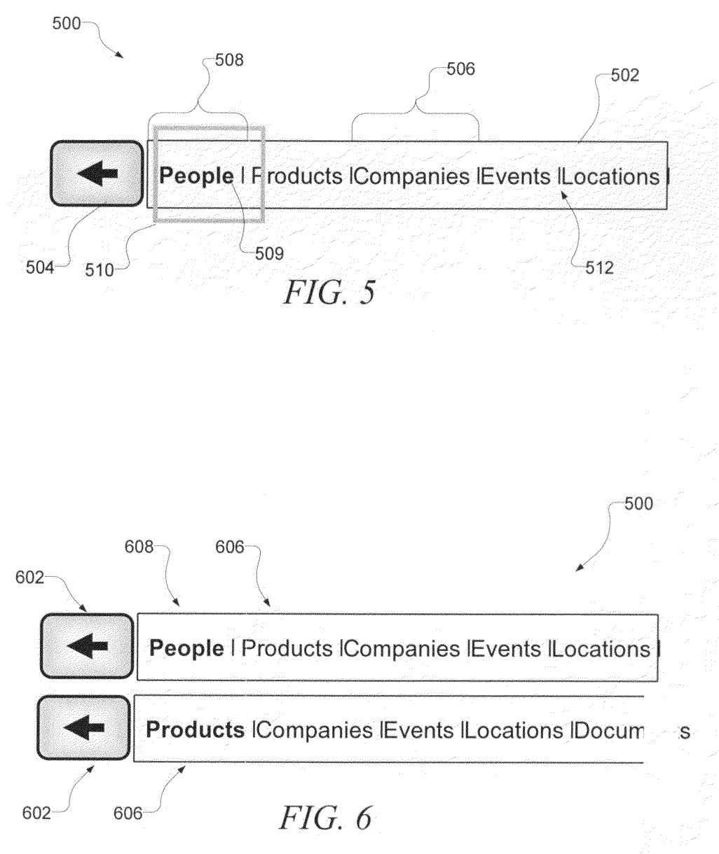

FIG. 5 is a graphical display of a single-step selector structure 500, including a presentation window 502 and an associated advance input mechanism in the form of an action button 504. The presentation window includes a number of discrete presentation positions 506, one of which is recognized as an invariant selection location (e.g., focus location) 508. In the example embodiment, a graphical box 510 visually designates and identifies the invariant selection location. Shown displayed within the selection window are multiple data items of a looped list, with respective data items being located within respective presentation positions. Graphical spaces 512 may be displayed between each of the data items so as to visually demarcate the presentation positions within the presentation window 502.

In the example selector structure 500 of FIG. 5, the action button displays a left arrow to indicate the direction in which the list of data items is advanced responsive to a selection of the action button 504. The action button 504 is furthermore located left of the horizontal list of data items, that may in other embodiments can be located to the right of a horizontal data item list (e.g., in right-to-left reading cultures). In addition to scrolling or advancing the data item list, the action button 504 may be combined with for example, an action bar (not shown) which can contain one or more functions that can be applied to a selected data item 509 located at the invariant selection location 508.

Moving on to FIG. 6, behaviour of the example single step selector 500 will now be described. In the example embodiment, the user operates the action button 504 (e.g., by a mouse click or keyboard navigation) to advance the list of data items in the direction indicated by the arrow of the action button. In an example embodiment, the action button 504 may support only discrete operations (e.g. resembling “toggling”), in that the button 504 may not support analogous scrolling.

When comparing the depiction of the selector indicated generally at 602 compared to that shown and designated generally at 604, it will be noted that the list of data items has moved, from the stage shown at 602, to the stage shown at 604. Accordingly, viewing the list of data items from left to right, the previously second item 606 has advanced, at the stage shown at 604 to become the first, and accordingly selected, data item. Accordingly, the selected data item may be regarded as receiving “focus”, and may be visually distinguished from other data items in the list (e.g., by being highlighted or displayed in a bold font. In one embodiment, as shown in FIG. 5, the selected data item may be visually highlighted by displaying the frame or box 510 around the selected data item.

It will be further noted that the previously selected data item (e.g., the “people” data item 608) disappears or becomes hidden as a result of the advancing operation. The “people” data item 608 may again be displayed (and potentially highlighted) by a repeated operation of the action button 504 which causes a looping of the list of data items. For each selection operation with respect to the action button 504, the looped list may perform a step-wise movement from left to right, resembling a “skip” behaviour, as opposed to a continuous scrolling behaviour. A continuous and enduring the selection of the action button 504 may cause the advancing of the looped list to move from a “skip” selection to a continuous scrolling selection, where the linked list of data items is continually scrolled through the presentation positions of the presentation window 502.

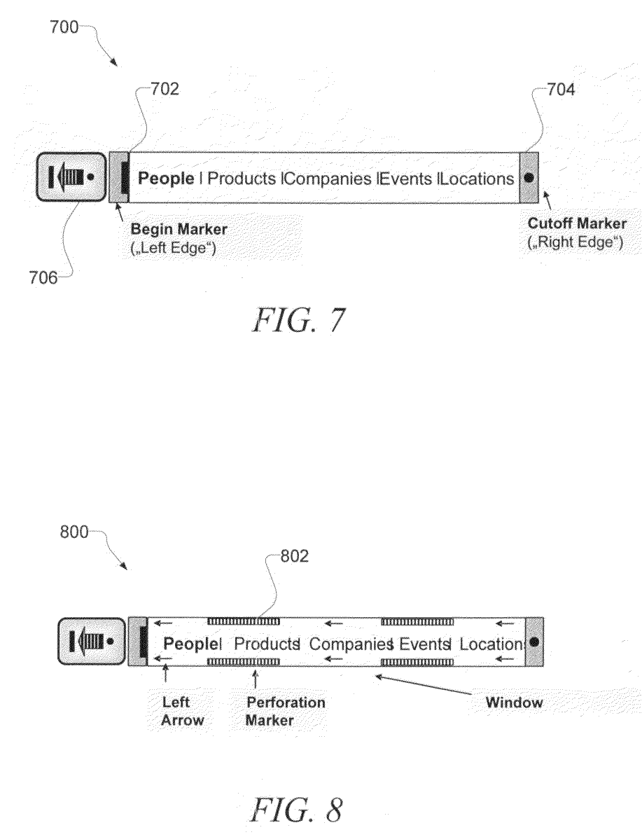

FIG. 7 illustrates a skip selector structure 700, according to a further embodiment, which includes begin and cut off markers 702 and 704 to provide visual designations regarding the beginning and the end of the portion of the linked list displayed within the presentation window. Further, it will be noted that certain additional visual clues are provided within the skip selector 700 to facilitate user inferences regarding the behaviour of the control. Specifically, within an action button 706, indicators are provided adjacent the right and left edges of an arrow, corresponding to indicators associated with the begin and cut off markers 702 and 704.

FIG. 8 is a graphical presentation of a further skip selector 800, according to an example embodiment, that offers additional visual clues, as compared against the visual designs shown in FIGS. 7 and 5, in order to facilitate inferences concerning behaviour of the control. Additionally, it will be noted that perforation markers 802 are included, which represent perforations on a film stock which moves when the film is transported within the body of a camera or a projection device. This, in conjunction with the arrows displayed within the selection window, may provide user inferences regarding the direction of movement of the looped list and provide some intuitive clues regarding the functioning of the relevant control.

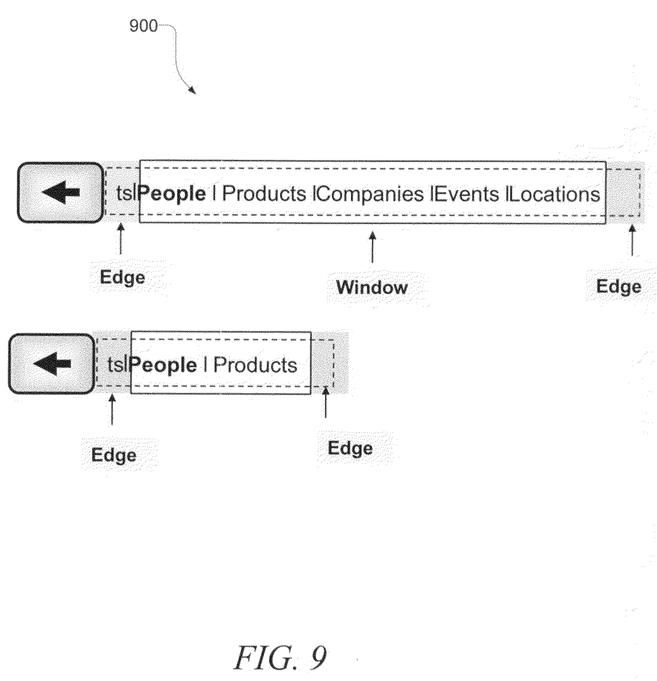

FIG. 9 is a graphical representation of a skip selector 900, according to yet a further example embodiment. The design variant illustrated in FIG. 9 reiterates the metaphor of transport, while emphasizing that the edges beyond it disappear or are hidden. The design variant shown in FIG. 9 may prove to be useful when a visible area within a user interface is less wide because the area with occluded items helps the user grasp the idea of moving the list along a visible window.

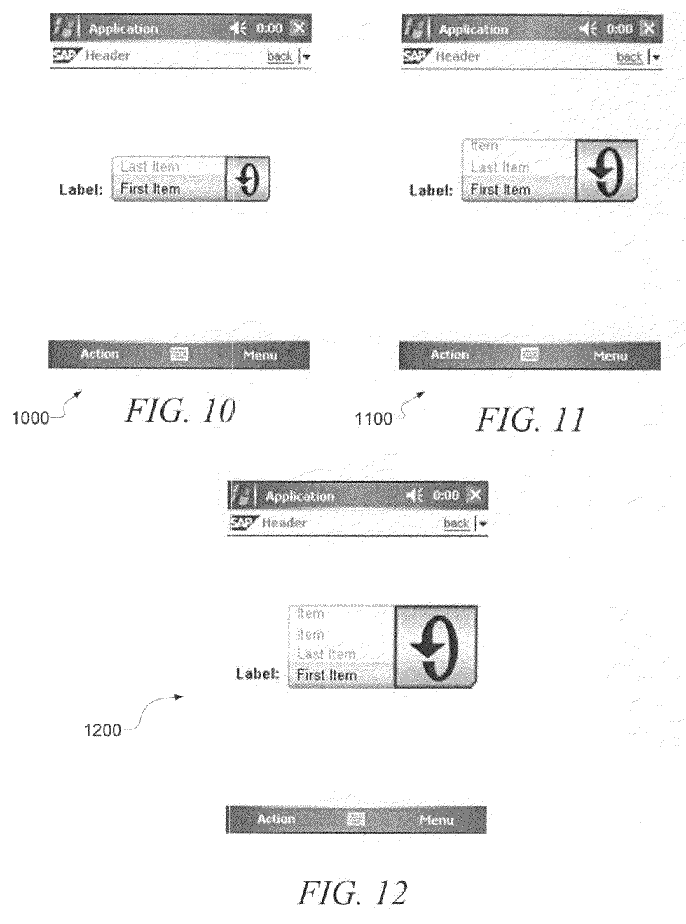

FIGS. 10-12 are screenshots, displaying respective examples of graphical user interfaces including selection windows within which the list of data items are scrolled vertically. In FIG. 10, an example embodiment is shown in which only two data items from a looped list are shown at any one time, whereas the variations are shown in FIGS. 11 and 12 display three and four data items within the selection window, respectively.

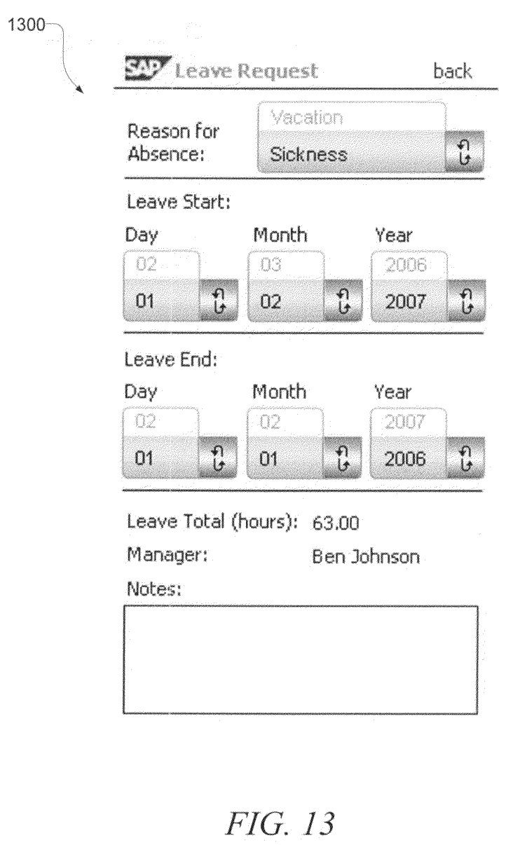

FIG. 13 is a screenshot illustrating a further graphical user interface 1300, according to an example embodiment of the present invention, where a number of selection windows are included within a single graphical user interface, each of the multiple selection windows are displaying a respective list of data items that are valid inputs for the respective fields. Again, each of the looped lists is advanceable to locate a selected data item within an invariant selection location in the manner described above.

It will be appreciated that the above described example selectors, which use a single invariant selection location, may provide certain advantages. For example, where a list of data items are presented within a graphical user interface with radio buttons (for single selection of item) or with check boxes (for multiple selections) such selection mechanisms may use up more screen area or “real estate” than the above described example selectors. Specifically, radio buttons and check boxes may consume more space, since each data item in the presented list needs to have a related radio button or check box displayed adjacent to the relevant data item.

Further, such lists with associated radio buttons or check boxes typically require the user to visually scan the entire list of data item options, in order to verify a selected item. While such a data list with associated radio buttons may, of course, be sorted alphabetically, it may be difficult to re-sort such a list according to a use or selection frequency. Accordingly, in one example embodiment, the ordering of the data items presented within the example select windows discussed above (e.g., the selection window 500 described with reference to FIG. 5) may be sorted according to frequency of usage, with the most frequently selected data item (e.g., data item 509) being presented as a default in the invariant selection location 508.

Considering dropdown menus, such menus typically require that the width of the menu (or box within which the menu is presented) correspond to the width of the longest data item displayed therein. Further, when navigating such dropdown menus, a user needs to manually move a selection mechanism up and down the menu, and track which data item is currently being selected. This may require the user to more carefully control the selection mechanism, and this may require a higher degree of concentration and skill to perform a selection, than would be required to perform a selection utilizing the example selectors described herein.

It will also be appreciated that the provision, in certain example embodiments, of a fixed advance input mechanism (e.g., the action button 504), in combination with a fixed and invariant selection location (e.g., the location 508) minimizes the amount of control that a user may be required to exert within a user interface in order to progress through a range of selections (e.g., presented in a linked loop of data items). Specifically, the advancement of selection options may only require that a selection or input operation be performed at one location (e.g., at or with the action button 504). Further, the user's visual attention can be focused on one area (e.g., the invariant selection location) to determine which data item from a list of data items is currently selected. By displaying the action button 504 and the invariant selection location 503 adjacent to each other, as is shown in FIG. 5, the amount of screen real estate to which a user needs to pay attention may be reduced. This may prove particularly advantageous on mobile devices or where the user has a limited attention span, for example, due to operating conditions. Consider the example use scenario in which a selector (e.g., the selector 500) is presented within a display in an automobile so as to enable a user to select between functions provided by automotive electronics (e.g., a navigation or audio system). In this use case scenario, the action button 504, for example, may be associated with a physical input mechanism of the display system (e.g., a button on the steering wheel of the automobile), and accordingly a user may conveniently, by pressing this button, be able to advance menu choices through an invariant selection location. The selector, as displayed on a console of an automobile, would require that the user only focus his or her attention on the invariant selection location 508 to determine a current menu selection. This may in turn reduce the amount and duration of attention that a driver of the motor vehicle needs to devote to performing a selection from a particular menu or a choice of data items.

Further, while a user's attention may be focused on the adjacent display of the action button 504 and the invariant selection location 508, a user is nonetheless provided with a limited view of other data item choices (e.g., a subset of a complete set of data items) within the other presentation locations 506 of the selection window 502. The number of additional presentation locations 506 that may be presented within a presentation window 502 may be varied according to the anticipated application (e.g., the number presented within an automotive use scenario may be less than within a handheld device use scenario). Further, in one example, the number of presentation locations 506 may dynamically be varied, by the presentation module 112, responsive to use conditions. For example, within the context of the automobile example provided below, the selection window 500 may be expanded, to show a greater number of presentation locations 506, when the vehicle is stationary and the user is able to pay greater attention to the selector 500. However, when the vehicle begins to move, and is accordingly being operated by the user, the number of presentation locations 506 may be dynamically reduced in order to present less information regarding non-selected data items to the user. It may also be envisaged, in one example embodiment, that the display of all of the presentation locations, except for the invariant selection location 508, may be removed or hidden, either by design, or dynamically responsive to operating conditions. Extending the above automotive example, the selection window 502 may be shrunk to only display the invariant selection location 508 when conditions are detected that indicate driver attention should be focused elsewhere (e.g., the car has begun to move and the driver is soon to be required to focus on piloting of the automobile).

FIG. 14 is a block diagram of machine in the example form of a computer system 1400 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1400 includes a processor 1402 (e.g., a central processing unit (CPU), a graphics processing unit (GPU) or both), a main memory 1404 and a static memory 1406, which communicate with each other via a bus 1408. The computer system 1400 may further include a video display unit 1410 (e.g., a liquid crystal display (LCD) or a cathode ray tube (CRT)). The computer system 1400 also includes an alphanumeric input device 1412 (e.g., a keyboard), a user interface (UI) navigation device 1414 (e.g., a mouse), a disk drive unit 1416, a signal generation device 1418 (e.g., a speaker) and a network interface device 1420.

The disk drive unit 1416 includes a machine-readable medium 1422 on which is stored one or more sets of instructions and data structures (e.g., software 1424) embodying or used by any one or more of the methodologies or functions described herein. The software 1424 may also reside, completely or at least partially, within the main memory 1404 and/or within the processor 1402 during execution thereof by the computer system 1400, the main memory 1404 and the processor 1402 also constituting machine-readable media.

The software 1424 may further be transmitted or received over a network 1426 via the network interface device 1420 using any one of a number of well-known transfer protocols (e.g., HTTP).

While the machine-readable medium 1422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures used by or associated with such a set of instructions. The term “machine-readable medium” shall accordingly be taken to include, but not be limited to, solid-state memories, optical and magnetic media, and carrier wave signals. The invention can be implemented in digital electronic circuitry, or in computer hardware, firmware, software, or in combinations of them.

Embodiments can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method operations can be performed by one or more programmable processors executing a computer program to perform functions of the invention by operating on input data and generating output. Method operations can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks. The processor and the memory can be supplemented by, or incorporated in special purpose logic circuitry.

Embodiments may also implemented in a computing system that includes a back-end component, e.g., as a data server, or that includes a middleware component, e.g., an application server, or that includes a front-end component, e.g., a client computer having a graphical user interface or an Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Certain applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules may include hardware circuitry, optical components, single or multi-processor circuits, memory circuits, software program modules and objects, firmware, and combinations thereof, as appropriate for particular implementations of various embodiments.

Although specific example embodiments have been described, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
retrieving a plurality of data items to present to a user; recognizing a single invariant selection location within a presentation window;
presenting the plurality of data items to the user within the presentation window, each of the plurality of data items being presented in a respective presentation position defined within the presentation window
associating only a single advance mechanism with the presentation window, the single advance mechanism operative to receive an advance input to advance the presentation of the plurality of data items in a single direction relative to presentation positions defined within the presentation window;
receiving the advance input from the user via the advance mechanism; and
responsive to the advance input, advancing the presentation of the plurality of data items relative to the presentation positions defined within the presentation window to locate a selected data item of the plurality of data items at the invariant selection location.

2. The method of claim 1, including performing an operation associated with or related to the selected data item.

3. The method of claim 2, wherein the operation is automatically performed responsive to the location of the selected data item at the invariant selection location.

4. The method of claim 2, including receiving an action input, which is distinct from the advance input, and performing the operation responsive to both of the action input and the location of the selected data item at the invariant selection location.

5. The method of claim 1, wherein the associating of the single advance mechanism includes associating a control graphical icon, displayed within a graphical user interface, with the presentation window.

6. The method of claim 1, wherein the associating of the single advance mechanism includes associating a physical input mechanism of a device, on which the plurality of the data items is displayed, with the presentation window.

7. The method of claim 1, wherein the plurality of data items comprises a list of data items, and the presenting of the plurality of data items includes presenting a menu to the user including the list of data items.

8. The method of claim 1, including presenting the presentation window within a graphical user interface.

9. The method of claim 8, wherein the presenting of the plurality of data items includes the presenting at least the first and second data items of the plurality of data items in the presentation window while hiding a third data item of the plurality of data items from presentation within the presentation window.

10. The method of claim 1, wherein the receiving of the advance input includes receiving a discreet input via the advance mechanism, and the method includes advancing the plurality of data items by a single increment of presentation positions defined within the presentation window.

11. The method of claim 1, wherein the receiving of the advance input includes receiving a continuous input via the advance mechanism, and continuously advancing the plurality of data items, relative to the presentation positions defined within the presentation window, for a duration of the continuous input.

12. The method of claim 1, wherein the advancing of the presentation of the plurality of data items includes at least one of the vertically or horizontally skipping or scrolling the plurality of data items.

13. The method of claim 1, wherein the receiving of the advance input includes receiving a discreet input via a voice activated advance mechanism.

14. A system comprising:
a data interface to retrieve a plurality of data items to present to a user via a graphical user interface;
a presentation module to present a single invariant selection location within a presentation window; to present the plurality of data items to the user within the presentation window, each of the plurality of data items being presented in a respective presentation position defined within the presentation window; and to associate only a single advance mechanism with the presentation window, the single advance mechanism operative to receive an advance input to advance the presentation of the plurality of data items in a single direction relative to presentation positions defined within the presentation window; and
an input interface to receive the advance input from the user via the advance mechanism as displayed within the graphical user interface; and
the presentation module, responsive to the advance input, to advance the presentation of the plurality of data items relative to the presentation positions defined within the presentation window to locate a selected data item of the plurality of data items at the invariant selection location.

15. The system of claim 14, including an operation module to perform an operation associated with or related to the selected data item.

16. The system of claim 15, wherein the operation module is automatically to perform the operation responsive to the location of the selected data item at the invariant selection location.

17. The system of claim 15, wherein the input interface is to receive an action input from a user via the graphical user interface and the operation module is to perform the operation responsive to both of the action input and the location of the selected data item at the invariant selection location.

18. The system of claim 14, wherein the presentation module is to associate a control graphical icon, displayed within a graphical user interface, with the presentation window.

19. The system of claim 14, wherein the presentation module is to associate the single advance mechanism with the presentation window by associating a physical input mechanism of a device, on which the plurality of the data items is displayed, with the presentation window.

20. The system of claim 14, wherein the plurality of data items comprises a list of data items, and the presentation module is to present a menu to the user within the graphical user interface, the menu including the list of data items.

21. The system of claim 14, wherein the presentation module is to present at least the first and second data items of the plurality of data items in the presentation window while hiding a third data item of the plurality of data items from presentation within the presentation window.

22. The system of claim 14, wherein the input interface is to receive a discreet input via the advance mechanism, and the presentation module is to advance the plurality of data items by a single increment of presentation positions defined within the presentation window responsive to the received discreet input.

23. The system of claim 14, wherein the input interface is to receive a continuous input via the advance mechanism, and the presentation module is to continually advance the plurality of data items, relative to the presentation positions defined within the presentation window, for a duration of the continuous input.

24. The system of claim 14, wherein the presentation module is to display at least one of the advance mechanisms vertically or horizontally skipping or scrolling the plurality of data items.

25. A system comprising:
first means for receiving a plurality of data items to present to a user via a graphical user interface;
second means for presenting a single invariant selection location within a presentation window; for presenting the plurality of data items to the user within the presentation window, each of the plurality of data items being presented in a respective presentation position defined within the presentation window; and for associating only a single advance mechanism with the presentation window, the single advance mechanism operatively to advance the presentation of the plurality of data items in a single direction relative to presentation positions defined within the presentation window; and
third means for receiving an advance input from the user via the advance mechanism as displayed within the graphical interface; and
the first means responsive to the advance input, for advancing the presentation of the plurality of data items relative to the presentation positions defined within the presentation window to locate a selected data item of the plurality of data items at the invariant selection location.

26. A machine-readable medium embodying instructions that, when executed by a machine, cause the machine to perform the following operations:
retrieving a plurality of data items to present to a user;
recognizing a single invariant selection location within a presentation window;
presenting the plurality of data items to the user within the presentation window, each of the plurality of data items being presented in a respective presentation position defined within the presentation window
associating only a single advance mechanism with the presentation window, the single advance mechanism operative to receive an advance input to advance the presentation of the plurality of data items in a single direction relative to presentation positions defined within the presentation window;
receiving the advance input from the user via the advance mechanism; and
responsive to the advance input, advancing the presentation of the plurality of data items relative to the presentation positions defined within the presentation window to locate a selected data item of the plurality of data items at the invariant selection location.
